(19) United States
(12) Patent Application Publication
(10) Pub. No.: US 2005/0077327 A1
(43) Pub. Date: Apr. 14, 2005

(54) Tire carrier assembly

(76) Inventor: Michael Kenney, Mesa, AZ (US)

Correspondence Address: Wright Law Group, PLLC;Suite 2, 7201 West Oakland, Chandler, AZ, 85226, US

(21) Appl. No.: 10/959,691

(22) Filed: Oct. 5, 2004

Related U.S. Application Data
(63) Continuation-in-part of application No. 10/279,647, filed on Oct. 24, 2002.

(51) Int. Cl. B62D 43/00; B60R 9/00; B60R 11/00

(52) U.S. Cl. 224/42.21

(57) ABSTRACT

A tire carrier assembly with integrated “D-rings” includes a hinge-mounted tire carrier and light assembly with an integrated wiring harness. The light assembly includes a light source and the light source is configured to illuminate a license plate affixed to the tire carrier assembly. The hinge allows the tire carrier and spare tire to be positioned next to the vehicle for traveling (“closed position”) and positioned away from the vehicle for access to the rear storage area of the vehicle (“open position”). Additionally, the integrated wiring harness provides electrical power to the light assembly, enabling the light source to be energized in both the open and closed positions.

### RELATED APPLICATION

This application is a continuation-in-part of U.S. application Ser. No. 10/279,647, filed on Oct. 24, 2002, now pending.

### BACKGROUND OF THE INVENTION

1. Technical Field

The present invention relates generally to vehicles and more particularly to an assembly adapted to fasten a spare tire to an off-road vehicle or sport utility vehicle (SUV).

2. Background Art

Spare tires are almost always provided as standard equipment with most vehicles. In most passenger vehicles, the tire is located in the trunk or cargo compartment. Since most of these vehicles are utilized mainly for the movement of passengers, the trunk space is often under-utilized and the positioning of a tire in the trunk rarely occupies needed space. However, the situation with respect to light trucks, sport-utility and recreational vehicles, is much different. Due to the nature of these vehicles, interior storage space is often highly valued and an interior positioned tire would result in the undesirable reduction of precious cargo space. As a result, externally mounted tire carriers are often useful options for such vehicles.

One type of external tire carrier enables a tire to be mounted below or underneath the vehicle. However, this approach has proven relatively problematic for a number of reasons. Specifically, a tire mounted below the vehicle tends to reduce the vehicle's practical road clearance. This reduction in clearance may prevent the vehicle from entering into rough areas that require that the vehicle maintain a certain ground clearance. This is especially problematic for off-road vehicles where the primary function is carrying passengers and cargo to remote or relatively inaccessible areas over unpaved access roads. In some situations, it may be quite difficult to remove a tire from beneath a vehicle. For example, during inclement weather, accumulated water and/or mud may create an unpleasant tire-changing experience. Also, a tire carrier mounted beneath the vehicle may occupy space otherwise available for a secondary fuel tank.

A second and more popular type of tire carrier is secured to the rear of vehicles, either by attachment to the rear body panel of the vehicle or, in the alternative, by attachment to the bumper and secured to the vehicle through a body mounted latch. However, these tire carriers may also present certain concerns. For example, those tire carriers supported exclusively by the body panel of the vehicle tend to vibrate significantly whenever the vehicle is in motion. In some circumstances, the combined forces exerted on the body panel as a result of the carrier weight and vibration may cause damage to the body panel. The tire carriers supported primarily through connection with the bumper and a body mounted latch, while less vibratory while the vehicle is in motion, tend to place a significant amount of stress on the body mounted latch as a result of the inherent instability of the bumper attachment of the carrier. Further, mounting the tire carrier on the bumper typically requires significant and irreversible modification of the bumper.

Another consideration with many conventional externally mounted tire carriers is that they are not well suited for vehicles with a rear door that opens upwardly or outwardly. With these types of vehicles, attaching the tire carrier to the rear door or in front of the rear door of the vehicle would effectively prevent the lift door from opening and, therefore, would reduce or prohibit access to the rear of the vehicle. Additionally, many conventional rear-mounted tire carriers are located so as to practically obscure the license plate of the vehicle in an undesirable fashion. Even if the license plate is relocated so as to be readily visible, the light fixture associated with the license plate is often left behind since it is typically an integral part of the vehicle and has a non-relocatable wiring harness. This situation can be problematic because many state vehicle laws require a clearly visible and illuminated license plate mounted to the rear of the vehicle. Finally, while some tires are configured to be mounted on top of the cab of the vehicle, this solution may also present certain difficulties. For example, some people may have difficulty maneuvering the tire onto and off of the roof without help or without inadvertently damaging the roof.

Accordingly, without an improved externally mounted tire carrier assembly that provides for secure mounting and easy access to the tire, carrying a tire and/or replacing a flat tire on an SUV will continue to be sub-optimal.

### BRIEF SUMMARY OF THE INVENTION

A tire carrier assembly with integrated “D-rings” includes a hinge-mounted tire carrier and light assembly with an integrated wiring harness. The light assembly includes a light source and the light source is configured to illuminate a license plate affixed to the tire carrier assembly. The hinge allows the tire carrier and spare tire to be positioned next to the vehicle for traveling (“closed position”) and positioned away from the vehicle for access to the rear storage area of the vehicle (“open position”). Additionally, the integrated wiring harness provides electrical power to the light assembly, enabling the light source to be energized in both the open and closed positions.

### BRIEF DESCRIPTION OF DRAWINGS

The preferred embodiments of the present invention will hereinafter be described in conjunction with the appended drawings, wherein like designations denote like elements, and:

FIG. 1 is an exploded view of a tire carrier assembly in accordance with a preferred embodiment of the present invention;

FIG. 2 is a perspective view of a latch bracket assembly for a tire carrier assembly in accordance with a preferred embodiment of the present invention;

FIG. 3 is a perspective view of a hinge bracket assembly for a tire carrier assembly in accordance with a preferred embodiment of the present invention;

FIG. 4 is a perspective view of a lighting assembly for a tire carrier assembly in accordance with a preferred exemplary embodiment of the present invention;

FIG. 5 is a perspective view of the tire mounting portion of a swing arm for a tire carrier assembly in accordance with a preferred exemplary embodiment of the present invention; and

FIG. 6 is a perspective view of a tire carrier assembly extended laterally away from the vehicle in accordance with a preferred embodiment of the present invention.

### DETAILED DESCRIPTION

A tire carrier assembly with integrated “D-rings” includes a hinge-mounted tire carrier and light assembly with an integrated wiring harness. The hinge allows the tire carrier and tire to be positioned next to the vehicle for traveling (“closed”) and positioned away from the vehicle for access to the vehicle (“opened”). Additionally, the integrated wiring harness provides electrical power to the light assembly, enabling the light assembly to be energized in both the open and closed positions.

Many SUVs and off-road vehicles are presently equipped with manufacturer installed “D-rings” or tow rings that are mounted on the exterior of the vehicle. These D-rings are typically supplied so that the vehicle may be quickly coupled to an external load such as a trailer, boat, another vehicle and the like. Accordingly, the SUV or off-road vehicle may be quickly configured to tow the external load. In most cases, these D-rings are directly or indirectly coupled to the frame of the vehicle by inserting one or more mounting bolts into corresponding threaded apertures, thereby providing stability and strength for the D-rings. The D-rings may also be coupled to the frame of the vehicle using various techniques such as welding or the like.

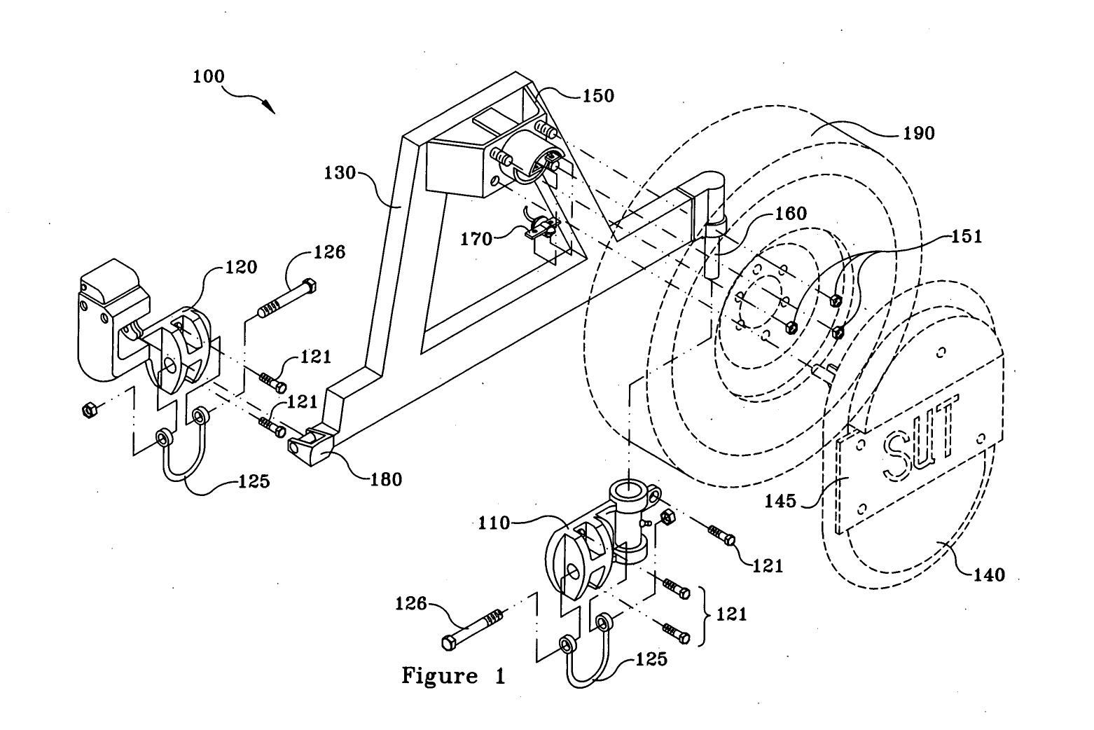

Referring now to FIG. 1, a tire carrier assembly 100 in accordance with a preferred exemplary embodiment of the present invention includes a hinge bracket assembly 110, a latch bracket assembly 120, a swing arm assembly 130, and a wheel cover 140. Swing arm assembly 130 comprises a tire mounting portion 150, a pin portion 160, a lighting assembly 170, and a coupling portion 180.

As shown in FIG. 1, hinge bracket assembly 110 and latch bracket assembly 120 are configured to be mounted to a vehicle (not shown this FIG.) by utilizing a plurality of mounting bolts 121. In the most preferred embodiments of the present invention, hinge bracket assembly 110 and latch bracket assembly 120 are configured to be mounted in the same location on a vehicle as the factory installed D-rings, to the extent that the vehicle had factory installed D-rings. D-rings 125 are most preferably attached to, and are integral components of, hinge bracket assembly 110 and latch bracket assembly 120. By inserting mounting bolts 121 through apertures formed in hinge bracket assembly 110 and latch bracket assembly 120, hinge bracket assembly 110 and latch bracket assembly 120 may be secured to the frame of the vehicle. By removing any factory installed D-rings and by using the existing mounting locations and apertures for installing hinge bracket assembly 110 and latch bracket assembly 120, drilling additional apertures in body of the vehicle can, in most instances, be avoided. For those vehicles without factory installed D-rings, appropriately positioned threaded apertures may be drilled into the vehicle as necessary to accommodate mounting bolts 121. Alternatively, hinge bracket assembly 110 and latch bracket assembly 120 may be secured to the frame of the vehicle by welding.

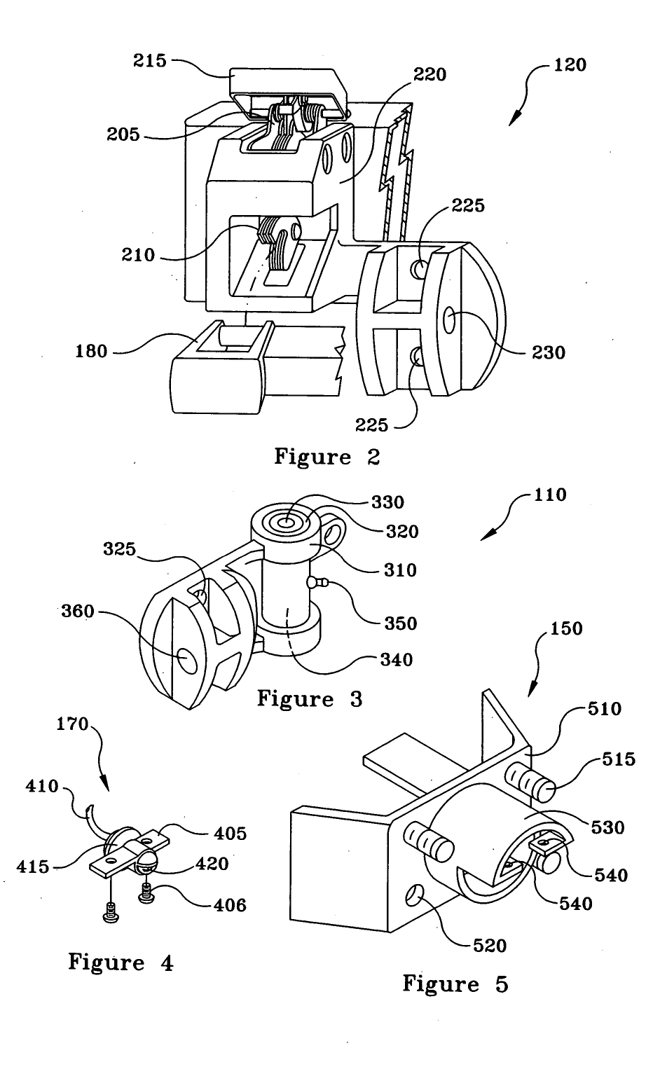

Swing arm assembly 130 is most preferably configured to be mounted to hinge bracket assembly 110 by inserting pin portion 160 of swing arm assembly 130 into an appropriately sized and positioned pin-receiving aperture in hinge bracket assembly 110. Swing arm assembly 130 is also most preferably configured to be selectively coupled to latch bracket assembly 120 via coupling portion 180. Latch bracket assembly 120 is configured to receive coupling portion 180 of swing arm assembly 130 and may be securely held in place by inserting the coupling portion 180 into a receiving mechanism, such as latch lock 220 of FIG. 2, thereby actuating the receiving mechanism and locking swing arm assembly 130 in position. After tire carrier assembly has been coupled to a vehicle in this fashion, a tire 190 may be mounted on tire mounting portion 150 of swing arm assembly 130 by utilizing a plurality of nuts 151.

While the various components of tire carrier assembly 100 may be manufactured from a variety of materials, in the most preferred embodiments of the present invention, hinge bracket assembly 110, latch bracket assembly 120, and swing arm assembly 130 are each manufactured from hardened steel and covered with a powder-coated finish to protect the various components of tire carrier assembly 100. Additionally, certain preferred embodiments of the present invention may incorporate machined-out portions on the various components such as hinge bracket assembly 110 and latch bracket assembly 120 that are especially useful for reducing the weight of hinge bracket assembly 110 and latch bracket assembly 120.

Wheel cover 140 is provided to cover tire 190 and can be provided with a locking mechanism (not shown this FIG.) to prevent undesirable tampering with mounting nuts 151. This can discourage potential thieves from attempting to remove tire 190 from tire carrier assembly 100. In the most preferred embodiments of the present invention, wheel cover 140 is also configured to receive and display a license plate. Additionally, wheel cover 140 may bear various artistic designs, advertising logos or indicia and the like.

In at least one preferred embodiment of the present invention, tire carrier assembly 100 is provided as an after-market accessory for off-road vehicles and sport utility vehicles. In yet another preferred embodiment of the present invention, tire carrier assembly 100 is a manufacturer or dealer installed option.

In addition to providing an improved tire carrier assembly, the methods of the present invention provide an improved method for mounting tire carrier assembly 100 to the exterior of a vehicle such as an SUV. Specifically, by utilizing the existing manufacturer-provided mounting apertures for the manufacturer-supplied D-rings to mount tire carrier assembly 100, tire carrier assembly 100 can be quickly and securely coupled to the frame of many vehicles. In many cases, this also allows tire carrier assembly 100 to be installed without any undesirable or permanent modification of the body or frame of the vehicle. Accordingly, the various preferred embodiments of tire carrier assembly 100 can be easily removed and the vehicle can be restored to its original condition by simply removing mounting bolts 121 along with all other components of tire carrier assembly 100, and then installing the original manufacturer supplied hardware, including mounting bolts 121 and any previously installed D-rings.

To install tire carrier assembly 100 to a vehicle, manufacturer supplied mounting bolts 121 and any manufacturer supplied D-rings are removed. Then, hinge bracket assembly 110 and latch bracket assembly 120 are positioned over the existing manufacturer provided mounting apertures for the now removed manufacture supplied D-rings. Next, the mounting apertures in hinge bracket assembly 110 and latch bracket assembly 120 are aligned with the existing manufacturer provided mounting apertures for the now removed manufacture supplied. Obviously, if a given vehicle does not have manufacturer installed D-rings and the corresponding mounting apertures, they may be installed as part of the overall process of installing tire carrier assembly 100.

After aligning all of the mounting apertures, mounting bolts 121 can be inserted through the mounting apertures and tightened in place, thereby securing hinge bracket assembly 110 and latch bracket assembly 120 to the frame of the vehicle. After securing hinge bracket assembly 110 and latch bracket assembly 120 in place, swing arm assembly 130 can be coupled to hinge bracket assembly 110 by inserting pin portion 160 of swing arm assembly 130 into the pin-receiving portion of hinge bracket assembly 110 and securing coupling portion 180 with latch bracket assembly 120 as described below in conjunction with FIG. 2.

Referring now to FIG.2, a latch bracket assembly 120 in accordance with a preferred exemplary embodiment of the present invention comprises a latch mechanism 205, a latch lock 210, a latch release lever 215, and a latch mechanism housing 220. As previously explained, mounting bolts 121 are used to secure latch bracket assembly 120 to a vehicle. Latch lock 210 is configured to receive coupling portion 180 of swing arm assembly 130 (as shown in FIG. 2). After receiving coupling portion 180 of swing arm assembly 130, latch mechanism 205 is actuated and fixed in the locked position, thereby securing swing arm assembly 130 (of FIG. 1) to latch bracket assembly 120. Latch mounting apertures 225 are each configured to receive a mounting bolt 121 (not shown this FIG.). D-ring aperture 230 is configured to receive a D-ring 125 (not shown this FIG.). When swing arm assembly 130 is to be released from latch bracket assembly 120, latch release lever 215 is depressed, thereby releasing latch mechanism 205 and, in turn, releasing coupling portion 180.

Referring now to FIG. 3, a hinge bracket assembly 110 in accordance with a preferred exemplary embodiment of the present invention includes a pin-receiving sleeve portion 310 and a D-ring aperture 360. Additionally, hinge bracket assembly 110 is most preferably configured with a freeze plug 340 and a grease plug 350. Sleeve portion 310 is configured to receive pin portion 160 of swing arm assembly 130 of FIG. 1. D-ring aperture 360 is configured to receive a D-ring 125 (not shown this FIG.). The most preferred embodiments of the present invention also comprise a rubber insert 320 and a bronze insert 330 inserted into sleeve portion 310. Rubber insert 320 is used to provide joint flexibility and “give” as swing are assembly 130 is rotated into the desired position. Bronze insert 330 is most preferably a machine bushing manufactured from a 660 bronze alloy and is provided to enhance the rotational movement of pin portion 160 of swing arm assembly 130 within sleeve portion 310 as swing arm assembly 130 is rotated into the desired position (opened or closed).

Freeze plug 340 is most preferably a selectively removable thin-walled disc inserted into the bottom of sleeve portion 310 and that can be removed, if necessary, to allow access to the interior of sleeve portion 310. This may be desirable in a situation where swing arm assembly 130 is “stuck” in place and corrective action is desirable. Grease plug 350 is configured to receive a lubricating material such as oil or grease so as to enhance the rotational movement of pin portion 160 of swing arm assembly 130 within sleeve portion 310 as swing arm assembly 130 is rotated into position. In the most preferred embodiments of the present invention, grease plug 350 is a standard “zerk-type” grease fitting, typically found in automotive applications.

Referring now to FIG. 4, light assembly 170 most preferably comprises mounting screws 406, an electrical supply cord 410, a mounting bracket 405, a light housing 415 and a light source 420. Mounting screws 406 are inserted into corresponding threaded openings in tire mounting portion 150 of swing arm assembly 130 of FIG. 1 and utilized to mount light assembly 170 to swing arm assembly 130 via mounting bracket 405. Light 420 is housed within, and electrically connected to, light housing 415 in a manner that allows light source 420 to be replaced without detaching any component of the lighting assembly, or adjacent parts, other than light source 420. As shown in FIG. 4, light housing 415 is affixed to or integrated with light mounting bracket 405. The most preferred exemplary embodiments of the present invention include a reflective shield integrated into light housing 415 and positioned over the top hemisphere of light source 420. This shield acts to reflect the light emitted by light source 420 downward, so as to provide increased illumination of the face of license plate 145 of FIG. 1.

Light source 420 may be any type of illumination device suitable for providing the desired level of illumination. In the most preferred embodiments of the present invention, light source 420 provides enough illumination so as to comply with any local, state, or federal regulations pertaining to illuminating license plates. In the most preferred embodiment of the present invention, light source 420 utilizes a standard automotive light bulb, similar to those used in conventional applications for illuminating a vehicle license plate. Light source 420 may be powered by any conventional means known to those skilled in the art including batteries and/or standard electrical wiring. However, in the most preferred embodiments of the present invention, light source 420 is connected to and powered by the standard electrical system of the vehicle to which swing arm assembly 130 is attached.

Referring now to FIG. 5, a swing arm assembly 130 of FIG. 1 in accordance with a preferred exemplary embodiment of the present invention includes a tire-mounting portion 150. Tire-mounting portion 150 of swing arm assembly 130 comprises a mounting plate 510 with a plurality of mounting bolts 515, at least one wheel cover mounting aperture 520, a tire mounting guide 530 and light fixture mounting apertures 540. Mounting portion 150 also includes a plurality of threaded mounting nuts 151 (not shown this FIG.). Mounting bolts 515 are most preferably threaded bolts securely coupled to mounting plate 510 and are used to couple the wheel of the tire to mounting plate 510. Mounting bolts 515 may be welded to mounting plate 510 or affixed using any other suitable attachment method known to those skilled in the art. In an alternative preferred exemplary embodiment of the present invention, mounting bolts 515 are an integral part of mounting plate 510 and are formed from a unitary piece of hardened steel. Mounting nuts 151 are most preferably internally threaded nuts and are removably fastened to mounting bolts 515, thereby securing a tire and wheel (not shown this FIG.) to mounting plate 510. In an alternative embodiment of the present invention, mounting bolts 515 are not threaded and mounting nuts 151 are held in place by selectively releasable compression fittings, spring-loaded fittings, or the like.

Tire mounting guide 530 comprises a cylinder with an upper half of a cylinder forming the outermost portion of tire mounting guide 530 so as to accommodate two light fixture mounting apertures 540 which are used to attach light assembly 170 to tire mounting portion 150 of swing arm 130. Additionally, tire mounting guide 530 is configured in such a way as to allow light source 420 to illuminate license plate 145 without obstruction, while at the same time, permitting the weight of tire 190 to bear down on the upper portion of tire mounting guide 530 during tire attachment and removal without damage to tire carrier assembly 100 or light assembly 170.

In the most preferred embodiments of the present invention, mounting bolts 515 and threaded mounting nuts 151 are sized and threaded to match the standard lug bolts and lug nuts for a typical vehicle. This makes it possible to interchange the regular lug nuts and mounting nuts 151. Additionally, any necessary replacement of lost or missing threaded mounting nuts 151 will be simplified. This feature also allows the same lug wrench to be used to remove the regular lug nuts and threaded mounting nuts 151.

When swing arm assembly 130 is coupled to latch bracket assembly 120 with latch lock 210, swing arm assembly 130 is fixed in position (closed). When release lever 215 is pulled upward causing latch mechanism 205 to be actuated to the unlocked position, coupling portion 180 of swing arm 130 is released from latch lock 210 of latch bracket assembly 120. Swing arm assembly 130 is then free to pivot in a substantially horizontal fashion, with hinge bracket assembly 110 acting as a hinge or pivot point. In this manner, swing arm assembly 130 can swing away from the vehicle to the open position and access to the rear door or cargo access of the vehicle is thereby provided. In the most preferred embodiments of the present invention, latch bracket assembly 120 and coupling portion 180 of swing arm 130 comprise a latch mechanism which allows for the displacement of swing arm assembly 130 between a closed position whereby swing arm assembly 130 is adjacent to a rear door and an open position whereby swing arm assembly 130 extends laterally away from the vehicle.

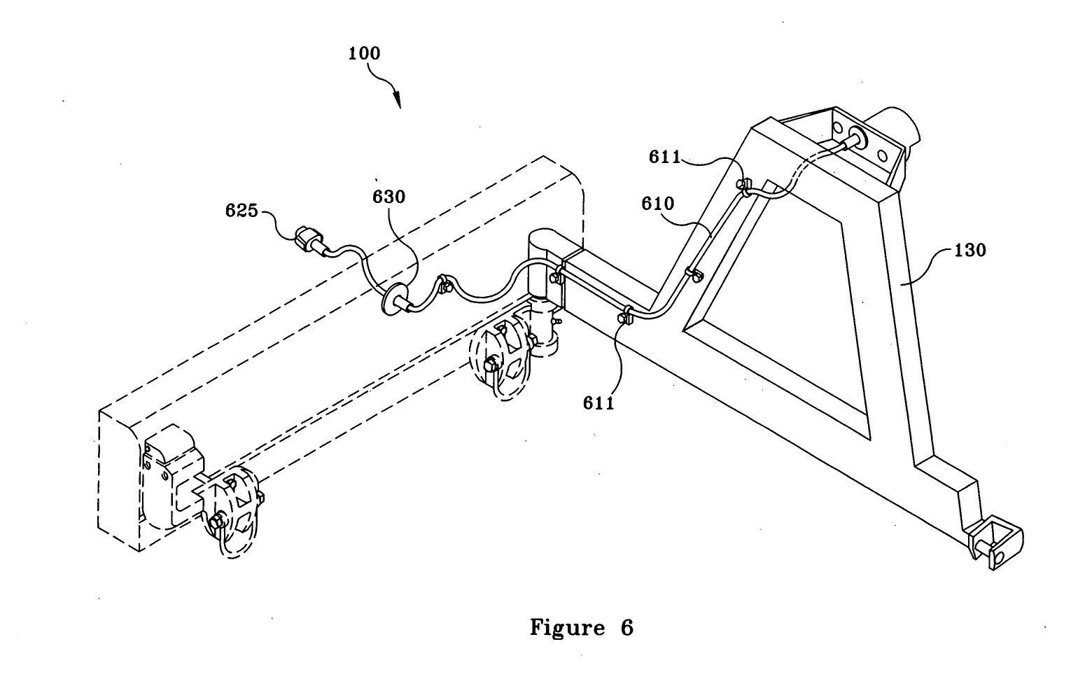

Referring now to FIG. 6, a perspective view of a tire carrier 100 in accordance with a preferred embodiment of the present invention is shown in the opened position. As shown in FIG. 6, in the most preferred embodiments of the present invention, wire 610 is attached to the frame of the vehicle using one or more fastener 611 and is also fastened with additional fasteners 611 to a point at or near the center of rotation of swing arm assembly 130 and subsequently fastened with a plurality of fasteners 611 at multiple points on the back side of swing arm assembly 130, following which, wire 610 is electrically connected to light source 420 (not shown this FIG.). According to the preferred embodiments of the present invention, connector 625 may interface with a manufacturer-supplied connector, or wire 610 and accompanying light assembly 170 (not shown this FIG.) may be manufacturer supplied, thereby eliminating the need for connector 625. In the after-market configuration of the present invention, connector 625 extends through the body of the vehicle to which tire carrier assembly 100 is attached. In this case, a grommet 630 may be provided at the point where wire 610 enters the body of the vehicle.

From the foregoing description, it should be appreciated that apparatus and methods for a mounted tire carrier assembly are provided and present significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims.

1. A tire carrier assembly for mounting a spare tire to a vehicle comprising:
a hinge bracket assembly;
a latch bracket assembly;
a swing arm assembly configured to be pivotably mounted to said hinge bracket assembly and selectively coupled to said latch bracket assembly; and
a light assembly coupled to said swing arm assembly, said light assembly comprising a light source.

2. The tire carrier assembly of claim 1 wherein said hinge bracket assembly further comprises an integrated D-ring.

3. The tire carrier assembly of claim 1 wherein said latch bracket assembly further comprises an integrated D-ring.

4. The tire carrier assembly of claim 1 wherein said hinge bracket assembly further comprises an integrated D-ring and said latch bracket assembly further comprises an integrated D-ring.

5. The tire assembly of claim 1, wherein said latch bracket assembly further comprises a latch mechanism, said latch mechanism being configured to selectively secure at least a portion of said swing arm assembly in a closed position.

6. The tire assembly of claim 1 further comprising a wheel cover configured to cover at least a portion of said tire.

7. The tire assembly of claim 6 further comprising a license plate affixed to said wheel cover.

8. The tire assembly of claim 1 wherein said latch bracket mechanism further comprises:
a latch mechanism; and
a release lever coupled to said latch mechanism, said release lever being configured to selectively actuate said latch mechanism.

9. The tire assembly of claim 1, wherein said swing arm assembly further comprises a pin portion, said pin portion being removably inserted into said hinge bracket assembly.

10. The tire carrier assembly of claim 1 wherein said hinge bracket assembly further comprises a grease plug, said grease plug being configured to receive a lubricating material.

11. The tire carrier assembly of claim 1 wherein said hinge bracket assembly further comprises a selectively removable freeze plug.

12. The tire carrier assembly of claim 1 wherein said hinge bracket assembly further comprises a bronze insert.

13. The tire carrier assembly of claim 1 wherein said hinge bracket assembly further comprises:
a bronze insert;
a selectively removable freeze plug; and
a grease plug, said grease plug being configured to receive a lubricating material.

14. The tire assembly of claim 7 wherein said mounting portion comprises:
a mounting plate;
a wheel cover mounting aperture;
a plurality of mounting bolts coupled to said mounting plate; and
a plurality of mounting nuts wherein said plurality of mounting nuts are removably fastened to each of said plurality of mounting bolts, thereby securing said tire to said mounting plate.

15. A tire carrier assembly for mounting a spare tire to a vehicle, said tire carrier assembly comprising:
a hinge bracket assembly with an integrated D-ring, said hinge bracket assembly comprising:
a bronze insert;
a selectively removable freeze plug; and
a grease plug, said grease plug being configured to receive a lubricating material;
a latch bracket assembly with an integrated second D-ring;
a swing arm assembly configured to be pivotably mounted to said hinge bracket assembly and selectively coupled to said latch bracket assembly, said swing arm assembly comprising a mounting plate;
a light assembly coupled to said mounting plate, said light being configured to illuminate a license plate;
a wiring harness, said wiring harness electrically coupling said light assembly to a power source associated with said vehicle;
a spare tire mounted to said mounting plate;
a wheel cover configured to be selectively attached to said spare tire; and
a license plate mounted to said wheel cover, said license plate being illuminated by said light assembly.

16. The tire assembly of claim 15, wherein said swing arm further comprises a pin portion, said pin portion being removably inserted into said hinge bracket assembly.

17. The tire assembly of claim 15 wherein said mounting plate comprises:
a tire mounting guide supporting said spare tire, said light assembly being attached to said tire mounting guide;
a plurality of mounting bolts coupled to said mounting plate; and
a plurality of mounting nuts wherein at least one of said plurality of mounting nuts is removably fastened to each of said plurality of mounting bolts, thereby securing said tire to said mounting plate.

18. A method of mounting a tire carrier assembly to a vehicle, said vehicle comprising a first and a second D-ring, wherein each of said first and second D-rings is coupled to said vehicle with a plurality of mounting bolts, said plurality of mounting bolts being inserted through a plurality of apertures in said first and second D-rings and into a plurality of vehicle apertures, the method comprising the steps of:
(a) removing said plurality of mounting bolts from said vehicle apertures, thereby removing said first D-ring and said second D-ring from said vehicle;
(b) positioning a hinge bracket assembly over said plurality of vehicle apertures, said hinge bracket assembly comprising an integrated D-ring and a plurality of mounting apertures;
(c) inserting a plurality of mounting bolts through said plurality of mounting apertures in said hinge bracket assembly and into said plurality of apertures in said vehicle apertures, thereby mounting said hinge bracket assembly to said vehicle;
(d) positioning a latch bracket assembly over said plurality of vehicle apertures, said latch bracket assembly comprising an integrated D-ring and a plurality of mounting apertures;
(e) inserting a plurality of mounting bolts through said plurality of mounting apertures in said latch bracket assembly and into said vehicle apertures, thereby mounting said latch bracket assembly to said vehicle;
(f) inserting a swing arm assembly into said hinge bracket assembly, said swing arm assembly comprising a light assembly coupled to said swing arm assembly;
(g) connecting said light assembly to a power supply contained within said vehicle.

19. The method of claim 18 further comprising the steps of:
mounting a spare tire to said tire carrier assembly;
mounting a cover on said spare tire, said cover comprising a license plate; and
configuring said light assembly to illuminate said license plate.

20. The method of claim 18 wherein steps (d) and (e) are accomplished prior to steps (b) and (c).

21. The method of claim 18 further comprising the steps of selectively locking and unlocking said latch bracket assembly, thereby securing or releasing said swing arm assembly.
